(19) United States
(12) Patent Application Publication
(10) Pub. No.: US 2025/0325962 A1
(43) Pub. Date: Oct. 23, 2025

(54) Hydrophobic and Porous Sorbent Polymer Composites and Methods for CO2 Capture

(71) Applicant: Battelle Memorial Institute, Columbus, OH (US)

(72) Inventors: David P. Hopkinson, Morgantown, WV (US); Lingxiang Zhu, Bethel Park, PA (US); James S. Baker, South Park, PA (US); Patrick F. Muldoon, Pittsburgh, PA (US)

(21) Appl. No.: 19/186,539

(22) Filed: Apr. 22, 2025

Related U.S. Application Data
(62) Division of application No. 17/686,349, filed on Mar. 3, 2022, now abandoned.
(60) Provisional application No. 63/156,286, filed on Mar. 3, 2021.

(51) Int. Cl. B01J 20/32; B01D 53/02; B01D 67/00; B01D 69/02; B01D 69/12; B01D 71/32; B01J 20/10; B01J 20/22; B01J 20/26; B01J 20/28

(52) U.S. Cl. CPC B01J 20/3225; B01D 53/02; B01D 67/0095; B01D 69/02; B01D 69/12; B01D 71/32; B01J 20/103; B01J 20/226; B01J 20/261; B01J 20/28026; B01J 20/28033; B01J 20/3238; B01J 20/324; B01J 20/327; B01J 20/3285; B01D 67/0011; B01D 67/0013; B01D 2253/25; B01D 2257/504; B01D 2323/08; B01D 2323/12; B01D 2323/22; B01D 2325/12; B01D 2325/38; B01J 2220/46

(57) ABSTRACT

Sorbent polymer composites and a solution-casting method of making hydrophobic sorbent polymer composites for CO₂ adsorption applications are described. The sorbent polymer composites are comprised of a polymer matrix, a dispersed CO₂ sorbent, and an optional filler particle for hydrophobicity modification.

### RELATED APPLICATIONS

This application claims priority to U.S. Provisional Patent Application No. 63/156,286 filed 3 Mar. 2021.

### GOVERNMENT RIGHTS CLAUSE

This invention was made with Government support under contract 89243318CFE000003 awarded by the U.S. Department of Energy. The Government has certain rights in this invention.

### INTRODUCTION

Carbon dioxide (CO₂) capture from flue gas generated by fossil fuel-fired power plants has been proposed as an efficient approach to limit CO₂ emissions to the atmosphere. Due to the high cyclic CO₂ sorption capacity, well-tuned adsorption chemistry and non-volatility, solid sorbents are widely studied for CO₂ capture processes such as pressure swing adsorption (PSA) and temperature swing adsorption (TSA). Realistic applications of traditional solid sorbent systems face many challenges since moisture and heat management are problematic and solid-solid heat exchange is inefficient. Recently, a novel solid sorbent system, the sorbent polymer composite (SPC), has been developed to overcome those challenges in an energy-saving CO₂ capture process using TSA membrane contactors in Berger et al. Energy Procedia, 114, 2193-2202, (2017), U.S. Pat. Nos. 8,911,536, and 9,144,766. A SPC material is comprised of a powdered solid sorbent embedded into a hydrophobic and porous polymer matrix. It allows gases to permeate through and achieve full contact with the sorbents while rejecting water moisture in the CO₂ capture process. This feature allows the sorbents in SPCs to remain functional instead of being flooded with water, which is ubiquitous in flue gas. There is a growing demand to develop cost-effective materials for CO₂ capture, and this invention is to address such need.

There have been several reports of hollow fiber adsorbents for CO₂ removal from flue gas. For example, in Industrial & Engineering Chemistry Research, 48(15), 7314-7324, (2009), Lively et al. wet spinning was used to spin the hollow fiber adsorbents. Cellulose acetate and Zeolite 13X sorbent were used to form hybrid polymer-sorbent hollow fiber adsorbents, which are not hydrophobic.

Rezaei et al. in Aminosilane-grafted polymer/silica hollow fiber adsorbents for CO₂ capture from flue gas. ACS applied materials & interfaces, 5(9), 3921-3931, (2013) reported in the use of poly(ethyleneimine) grafted silica to improve CO₂ sorption capacity of the hollow fiber adsorbents. U.S. Pat. No. 8,133,308 also describes making sorbent hollow fibers are made through wet-spinning. Polymer/sorbent mixtures comprising solvents, non-solvents, additives such as lithium nitrate, and sorbents are extruded through a die into a non-solvent quench bath.

Khdary et al., Arabian Journal of Chemistry 13 (2020) 557-567 describe a phase separation technique to prepare a membrane from a composite containing polyvinylidene-fluoride-hexafluoropropylene (PVDF-HFP), amino-silica particles, acetone and water. PVDF-HFP was dissolved in acetone and amine modified SiO₂ particles were mixed with acetone. The water was added subsequently in the mixer to get 1:1 water to acetone weight ratio and stirred to achieve good dispersion of inorganic particles. Dip coating method was executed to develop a thin layer of porous polymer film on a glass microscope slide under ambient conditions. The porous polymer film thickness was controlled by adjusting withdrawal speed of the glass slide out of the dilute coating solution with 1 weight percentage of PVDF-HFP.

Numerous patents have described materials for CO₂ capture. U.S. Pat. No. 7,442,352 described SPC materials made from at least one fluoropolymer (exemplified by PTFE) and a sorbent material in the form of porous particles (exemplified by activated carbon) in a method described in Scheme 2 (see below) which involves high temperature and other harsh processing conditions. U.S. Pat. No. 8,911,536 described a polytetrafluoroethylene (PTFE) tape embedded with small sorbent granules. Liu in U.S. Pat. No. 8,262,774 disclose a CO₂ capture membrane comprising a PVDF-HFP film without embedded particles. U.S. Pat. No. 4,414,111 described a process in which an ionic group-containing acrylonitrile polymer is dissolved in a solvent and dispersing a powdery ion exchange type adsorbent in an inorganic solvent, then extruding the resultant into a coagulating liquid bath to effect coagulation-shaping. U.S. Pat. No. 7,311,832 reports a method of producing a flat-sheet type adsorption membrane with adsorbent particles incorporated into the pores. The method includes the following steps: (a) producing a polymer casting solution, (b) introducing adsorbent particles into the polymer casting solution, (c) converting the resulting solution to a membrane form, (d) placing the shaped solution in a precipitation bath to perform a controlled phase reversal, forming a porous membrane filled with particles and (e) removing the remaining solvent.

### SUMMARY OF THE INVENTION

In a first aspect, the invention provides a method of making a sorbent polymer composite membrane (preferably in the form of a flat sheet), comprising: mixing a dissolved fluoropolymer and a sorbent in an organic solvent to form a mixture; wherein the fluoropolymer and sorbent comprise at least 5 mass % of the mixture; adding a nonsolvent to the mixture to form a phase inversion coating composition; wherein the mass ratio of nonsolvent to solvent in the coating composition is 0.2 or less; applying a film of the coating composition to a substrate via a casting knife (doctor blading); vaporizing the solvent from the film at a temperature <150° C. from the mixture to increase the ratio of nonsolvent/solvent so that the fluoropolymer precipitates from the solvent; and forming a porous fluoropolymer film with dispersed sorbent.

Any aspect of the invention can be further characterized by one or any combination of the following features: further comprising drying the porous fluoropolymer film at an elevated temperature above 30° C. to remove the solvent and nonsolvent; wherein the elevated temperature is in the range of 30-100° C.; wherein the mixture comprises at least 7 mass %, or at least 8 mass %, or 8 to 15 mass %, or 8 to 10 mass % fluoropolymer plus sorbent; wherein the mixture comprises at least 4 mass %, or at least 8 mass %, or 8 to 15 mass %, or 5 to 20 mass % or 8 to 10 mass % fluoropolymer; wherein the coating composition has a mass ratio of nonsolvent/solvent (for example water/acetone) of 0.2 or less, or 0.1 or less, or 0.02 to 0.10, or 0.04 to 0.08 or 0.024-0.100; wherein the step of vaporizing is conducted at <150 or <100 or <80° C., or in the range of 10⁻³⁰° C.; wherein the substrate is a fabric and the coating composition impregnates and adheres to the fabric or wherein the substrate is a smooth solid substrate (such as a glass plate, steel belt or plastic board) on which the coating composition can form free-standing membranes and be peeled off subsequently; wherein the sorbent comprises a zeolite, an activated carbon, a MOF, an amine grafted or impregnated silica, an amine functionalized MOF, or an amine impregnated polymer; wherein the substrate is a wet (water-containing) fabric; wherein the casting knife gap clearance is set in the range of 0.2-1.0 mm; wherein the fluoropolymer and sorbent are adjusted so that the sorbent in the resulting membrane is in the range of 15-75 weight percent; wherein the solvent is evaporated over a period of from 10 minutes to 24 hours, or 10 to 60 minutes, or 10 to 30 minutes or 1 to 10 minutes; wherein the MOF comprises UiO-66, MOF-808, Mg₂(dobdc), or combinations thereof; wherein the MOF comprises an amine functionalized MOF such as UiO-66-NH₂; comprising a plurality of MOFs.

The invention also includes a membrane made by any of the methods described herein.

In another aspect, the invention provides a sorbent polymer composite membrane comprising: a porous fluoropolymer, a solid sorbent dispersed in the porous membrane, and optionally a fabric layer in the membrane or adhered to the membrane;
wherein the membrane has a surface characterizable by a water contact angle >100°; and an air, nitrogen, and/or CO₂ permeance: >10000 GPU (1 GPU=7.501×10⁻¹² m³ (STP) m 2 s⁻¹ Pa⁻¹).

In a further aspect, the invention provides a sorbent polymer composite membrane comprising: a fluoropolymer matrix, a polytetrafluoroethylene (PTFE) filler, and a dispersed adsorbent, wherein the membrane has a surface characterizable by a water contact angle >100°, or from 101° to 131°.

Any aspect of the invention can be further characterized by the sorbent polymer composite membrane further characterized by one or any combination of the following features: having a thickness of 20-200 μm; having CO₂ adsorption capacity >0.2 mmol CO₂ per gram adsorbents at CO₂ partial pressure of 0.1 bar, or >2 mmol CO₂ per gram adsorbents at CO₂ partial pressure of 1.0 bar; having reversible CO₂ adsorption capacity in claim 17 after thermal regeneration of adsorbents at >80° C. for >10 times, or 100 times, or >1000 times; having reversible CO₂ adsorption capacity in after exposures to water steam at 100° C. for >10 times, or 100 times, or >1000 times; where each water steam exposure duration in claim 19 ranging from 10 seconds to 10 minutes; wherein the fluoropolymer matrix is made of poly(vinylidene fluoride) (PVDF), poly(vinylidene fluoride-co-trifluoroethylene) (PVDF-TrFE), poly(vinylidene fluoride-co-chlorotrifluoroethylene) (PVDF-CTFE), and combinations thereof; wherein the PTFE filler has a mean particle diameter (by number), characterizable by scanning electron microscopy, preferably at 5-2000 nm, more preferably at 20-1000 nm, and most preferably 100-500 nm; wherein the PTFE filler has at least 1 mass %, or preferably 1 to 40 mass %, or more preferably 10 to 30 mass %, or most preferably 15-25 mass % relative to the combined mass of fluoropolymer, PTFE, and adsorbent; wherein the fluoropolymer has a preferred mass % of 10⁻⁷⁰, a more preferred mass % of 20-60, and the most preferred mass % of 30-50; wherein the adsorbent has a preferred mass % of 10⁻⁸⁰, a more preferred mass % of 30-80, and the most preferred mass % of 40-60, relative to the combined mass of fluoropolymer, PTFE, and adsorbent.

In a further aspect, the invention provides a method of functionalizing metal-organic frameworks (MOFs) with amines in a single step without the use of any organic solvents; wherein any MOF containing coordination sites available for carboxylate binding is soaked in an aqueous solution comprising a strong base and a molecule which contains both amine(s) and carboxylic acid groups (e.g., any amino acid). The carboxylate group of the amine-containing molecule is in excess to the MOF and thus displaces native ligands on the metal ions or metal oxo clusters of the MOF. The inclusion of a strong base ensures that the amine groups in the resulting material will be in a neutral (deprotonated) state without the need for any additional steps/reagents. The amount of strong base included is adjusted so as to make the pH of the amine-containing solution as high as possible without resulting in the degradation of the MOF (characterized by a loss of crystallinity of at least 5% or at least 10% or at least 20% as measured by a technique such as X-ray crystallography or a large decline (>25%) in surface area). Strong bases are compounds that dissociate essentially completely in water, especially alkali and alkaline earth hydroxides.

The membrane can be further characterized by any of the properties described herein including properties or features resulting from the methods. The invention includes membrane contactors for CO₂ removal from flue gas generated from fossil fuel fired power plants and methods of capturing CO₂ using membranes as described herein. The invention also includes methods of capturing H₂S, sulfur oxides, and/or Hg; for example, SPC can also be applied in sour gas (H₂S and CO₂) removal from shale gas, sour gas (H₂S and CO₂) removal from natural gas, and removal of sulfur oxides and mercury vapor from a flue gas stream. The invention also includes systems comprising any combination of the membranes, fluid components, and/or conditions of manufacture or operation. The systems, membranes or other components, in any aspect, can be further characterized by any of the data in the text or figures.

Various aspects of the invention are described using the term “comprising;” however, in narrower embodiments, the invention may alternatively be described using the terms “consisting essentially of” or, more narrowly, “consisting of.”

### BRIEF DESCRIPTION OF THE DRAWINGS

FIG. 1a Chemical structure of PVDF-HFP copolymer.

FIG. 1b Scanning electron microscopy (SEM) image of the UiO-66 nanoparticles.

FIG. 1c Scanning electron microscopy (SEM) image of the UiO-66-NH2 nanoparticles.

FIG. 1d Scanning electron microscopy (SEM) image of the glycine MOF-808 nanoparticles.

FIG. 2a Characterizations on SPC #1 comprised of 75 wt. % PVDF-HFP/25 wt. % UiO-66: surface SEM image.

FIG. 2b Water contact angle test.

FIG. 2c Full cross-sectional SEM image.

FIG. 2d Zoom-in cross-sectional SEM image.

FIG. 3a Characterizations on SPC-2 comprised of 60 wt. % PVDF-HFP/40 wt. % UiO-66. SEM images of the surface.

FIG. 3b Full cross-section.

FIG. 3c Selected zoom-in cross-section.

FIG. 3d Water contact angle test.

FIG. 3e Photos of water dripping on the surface of a free-standing SPC-2 membrane.

FIG. 3f Photos of a woven metal fabric reinforced SPC-2 membrane.

FIG. 4a Characterizations on SPC-3 comprised of 60 wt. % PVDF-HFP/40 wt. % UiO-66-NH2. SEM images of the surface.

FIG. 4b Full cross-section.

FIG. 4c Selected zoom-in cross-section.

FIG. 4d Water contact angle test.

FIG. 5a Schematic of a laboratory scale fixed bed reactor used for evaluating CO₂ adsorption performance (Energy & Fuels, 27, 11, 6899-6905 (2013)).

FIG. 5b CO₂ adsorption performance of SPC-3.

FIG. 5c CO₂ adsorption performance of UiO-66-NH2 in dry and wet CO₂ mixtures at 35° C.

FIG. 6a SEM characterization on SPC-4 comprised of 60 wt. % PVDF-HFP/40 wt. % glycine MOF-808: surface at a magnification of 5000.

FIG. 6b SEM characterization on SPC-4 comprised of 60 wt. % PVDF-HFP/40 wt. % glycine MOF-808: surface at a magnification of 20000 times.

FIG. 6c Full cross-section of the SEM characterization on SPC-4 comprised of 60 wt. % PVDF-HFP/40 wt. % glycine MOF-808.

FIG. 6d SEM characterization on SPC-4 comprised of 60 wt. % PVDF-HFP/40 wt. % glycine MOF-808: selected zoom-in cross-section at a magnification of 20000 times.

FIG. 7a Upper surface of the SEM characterization.

FIG. 7b Cross-section of the SEM characterization.

FIG. 7c PVDF-HFP membrane containing 9.1 wt % PTFE nanoparticles of the SEM characterization.

FIG. 7d PTFE membrane containing 9.1 wt % PTFE nanoparticles of the SEM characterization.

FIG. 8a Upper surface of the SEM characterization.

FIG. 8b Cross-section of the SEM characterization.

FIG. 8c PVDF-HFP/PTFE/UiO-66-NH2 SPC containing 59 wt % PVDF-HFP, 22 wt % UiO-66 NH2.

FIG. 8d PVDF-HFP/PTFE/UiO-66-NH2 SPC containing 59 wt % PVDF-HFP, 22 wt % UiO-66 NH2, and 19 wt. % PTFE fillers

FIG. 9 (Scheme 1) illustrates a general procedure to prepare porous and hydrophobic SPCs (preferably at ambient conditions) in this invention.

FIG. 10 Scheme 2 A prior procedure to prepare the existing SPCs based on PTFE. Reported in U.S. Pat. No. 7,442,352 (2008).

### DETAILED DESCRIPTION OF THE INVENTION

The invention provides a facile method to fabricate (preferably flat-sheet) hydrophobic and porous sorbent polymer composites (SPCs) at ambient conditions and with mild solvents using solution-processable polymers and solid sorbents. Scheme 1 displays a general procedure to produce the SPCs. Step 1 involves the preparation of a polymer/sorbent suspension consisting of a hydrophobic polymer, a solid sorbent, a volatile solvent and a stable non-solvent. An appropriate pairing of the polymers and their solvent and nonsolvent is important in creating hydrophobic and porous structure in SPCs. In Step 2, the suspension is applied onto a substrate to form a SPC membrane using a casting knife. In Step 3, the SPC membrane is dried in controlled environment, in which the volatile solvent evaporates first, followed by evaporation of the non-solvent. The difference in evaporation rates of the solvent and nonsolvent leads to phase separation of polymers, resulting in a desirable structure with solid sorbents embedded in porous polymers. The ability to form SPCs without a precipitation bath is an improvement over prior methods such as described in U.S. Pat. No. 7,311,832 which require a non-solvent precipitation bath to induce polymer phase separation and thus create porous structure.

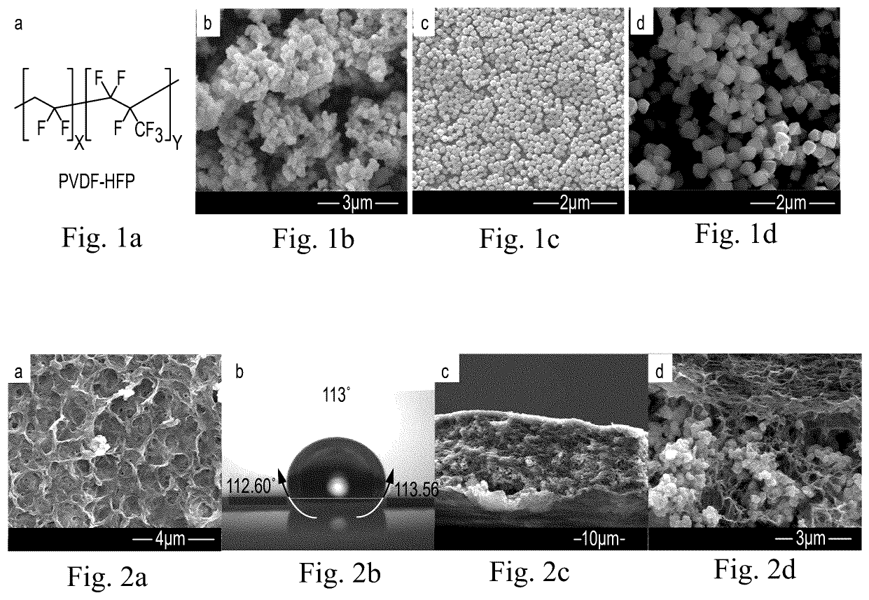

In our proof-of-concept study, commercially-available and low-cost poly(vinylidene fluoride-co-hexafluoropropylene) (PVDF-HFP) was selected as the polymer matrix. FIG. 1a shows the chemical structure of PVDF-HFP, which is a solution processable fluoropolymer due to its copolymer effect. It shows moderate hydrophobicity with a water contact angle of 89° when cast as a non-porous membrane with smooth surface. It has excellent thermal stability with a softening temperature at 140-150° C. These characteristics make PVDF-HFP an ideal polymer matrix for a SPC operating under hot and humid conditions for flue gas CO₂ capture. Acetone is employed was used as the solvent for the following reasons: (1) PVDF-HFP has good solubility in it; (2) it has low boiling point of 56° C. so it will evaporate rapidly after the SPC casting, leaving PVDF-HFP precipitated and phase separated in a non-solvent to form a porous structure; (3) it is a mild solvent that will not disrupt or dissolve the solid sorbents. Water is chosen as a non-solvent because it does not dissolve PVDF-HFP and can be easily removed after the evaporation of the volatile solvent (acetone). UiO-66 based metal organic frameworks (MOFs) were selected as solid sorbents. Here, UiO-66 was used as a physical sorbent, and UiO-66-NH₂ was employed as a chemical sorbent due to its amine chemistry on the surface. FIGS. 1b and c displays the microstructure of nano-sized UiO-66 (FIG. 1b) and UiO-66-NH₂ sorbents (FIG. 1c), and their synthetic methods are described in the literature (Cmarik et al, Langmuir, 2012, 28, 15606). The following Examples 1-3 demonstrate the feasibility of our method to fabricate porous and hydrophobic SPCs using UiO-66 and UiO-66-NH₂ adsorbents. Example 4 demonstrates the same method with glycine MOF-808 adsorbents (FIG. 1d) recently developed at NETL. The modification of porous PVDF-HFP's hydrophobicity via the addition of polytetrafluoroethylene (PTFE) nanoparticles is demonstrated in Example 5.

Generally, solution-processable fluoropolymers are useful in the present invention (PTFE is an example of a fluoropolymer that is not solution processable due to poor solubility). SPCS of the present invention can have the ability to function as free-standing films.

### Example 1: SPC-1 (75 wt % PVDF-HFP/25 wt % UiO-66)

A facile dry phase inversion method that is described in Scheme 1 was employed to prepare SPC-1. Specifically, 1.50 g PVDF-HFP (Number average molecular weight of 130,000 g/mol, Sigma Aldrich, St. Louis, MO), 0.50 g UiO-66, 1.13 g water, and 16.1 g acetone were mixed at 50° C. in a capped vial and then sonicated for 1 hour to form a suspension in the first step. Second, the suspension was cast on a glass substrate using a casting knife with gap thickness of 0.4-0.8 mm, followed by room temperature (22-25° C.) drying in a fume hood for 30 minutes. Finally, SPC-1 was obtained by peeling from the glass substrate after drying out. In the drying process, acetone evaporates initially due to its low boiling point (56° C.), leaving PVDF-HFP concentrated, precipitated and then phase separated in water to form a porous structure. FIG. 2a displays surface morphology of SPC-1 with porous structure. This porous surface exhibits excellent hydrophobicity, indicated by a water contact angle of 113° (FIG. 2b). SPC-1 also has porous structure throughout the cross-section (FIG. 2c), where UiO-66 sorbents are well dispersed among the porous polymer matrix (FIG. 1d). The porous yet hydrophobic feature allows solid sorbents to adsorb CO₂ while preventing flooding in CO₂ capture processes in the presence of water moisture.

### Example 2: SPC-2 (60 wt % PVDF-HFP/40 wt % UiO-66)

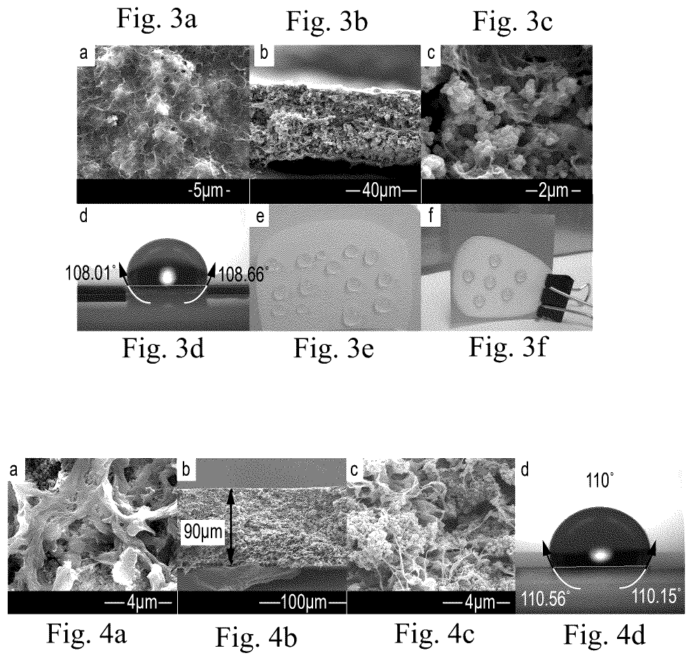

To improve CO₂ sorption capacity of SPCs, a high sorbent loading SPC material, SPC-2, was fabricated following the method described in Example 1, except that PVDF-HFP and UiO-66 sorbent were mixed at a weight ratio of 60/40. More specifically, the prepared suspension comprises 1.50 g PVDF-HFP, 1.00 g UiO-66, 1.13 g water, and 16.1 g acetone. The obtained free-standing SPC-2 membrane was characterized by SEM. FIG. 3a displays porous surface of SPC-2 with decorated UiO-66 nanoparticles. FIG. 3b shows many UiO-66 sorbents are uniformly integrated in the porous PVDF-HFP matrix across a 40 μm thick SPC-2 membrane, and a zoom-in cross sectional image (FIG. 3c) confirms the nano-sized sorbent are well dispersed in the polymer networks. More importantly with such high sorbent loading, the porous surface of SPC-2 still exhibits outstanding hydrophobicity, indicated by a water contact angle of 108° (FIG. 3d), demonstrating its potential to repel water moisture. For example, after spraying water drops onto a free-standing SPC-2 membrane as shown in FIG. 3e, water cannot wet the SPC-2 but tends to drip from the surface, again demonstrating the impressive water-repellent ability of SPC-2. In addition, the fabrication method described in Scheme 1 is versatile. Using a smooth and solid substrate, like a glass plate, in Step 2 (Scheme 1), SPC membranes can be peeled from the solid substrate to achieve a free-standing membrane. If a porous substrate, like woven or non-woven fabrics, is applied in Step 2, fabric reinforced SPC membranes can be obtained. For example, FIG. 3f shows a stainless-steel woven metal fabric (mesh size 325×2300, McMaster-Carr, Elmhurst, IL) reinforced SPC-2 membrane. Adding a support layer would enhance mechanical strength of SPC without changing the porous and hydrophobic feature of SPC materials.

### Example 3: SPC-3 (60 wt % PVDF-HFP/40 wt % UiO-66-NH₂)

Due to amine-CO₂ chemical interactions, solid sorbents functionalized with amine groups have essentially higher CO₂ sorption capacity compared to physical sorbents. To enhance CO₂ sorption capacity of SPCs, SPC-3 material was developed by incorporating UiO-66-NH₂ sorbents into PVDF-HFP at a high sorbent loading of 40 wt. %. This SPC-3 was prepared following the method described in Example 2, except that UiO-66 sorbents were replaced by UiO-66-NH₂ sorbents. FIG. 4a displays surface morphology of SPC-3 with open-pore structure, and UiO-66-NH₂ nanoparticles well distributed inside the pores. This SPC membrane has a thickness of 90 μm (FIG. 4b) and a porous structure throughout the entire cross-section, where UiO-66-NH₂ sorbents are also uniformly dispersed among porous polymer matrix (FIG. 4c). Due to the highly porous structure, these SPC membranes are highly permeable to gas molecules with a CO₂ permeance as high as 60000 gas permeance units (1 gas permeance unit=10⁻⁶ cm³/cm² s cmHg). Even with the sorbent loading as high as 40 wt %, its porous surface still exhibits remarkable hydrophobicity with a water contact angle of 110° (FIG. 4d), confirming its water-repellent ability.

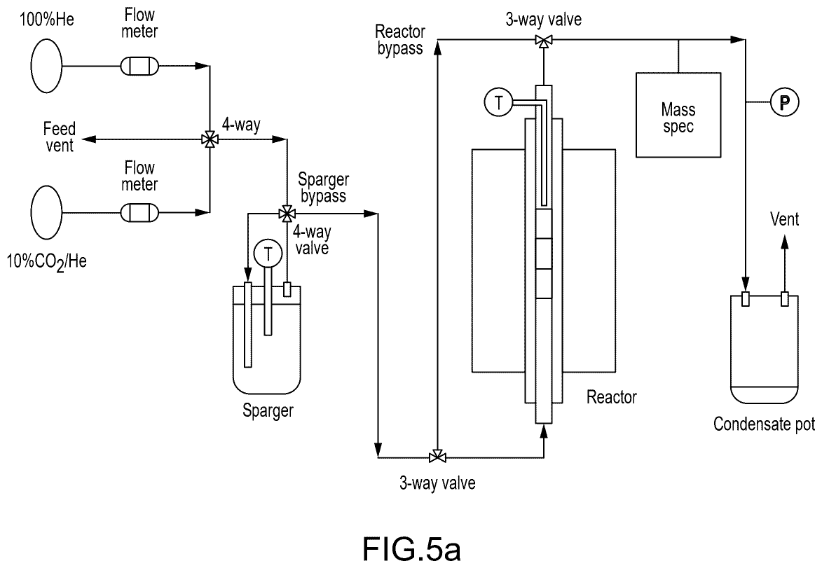

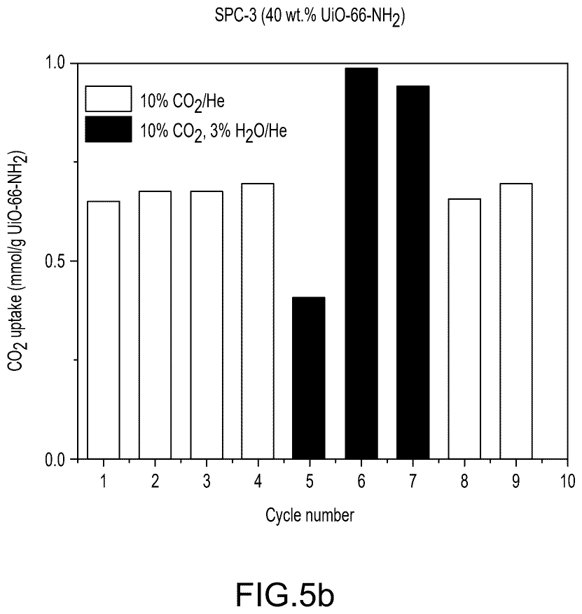

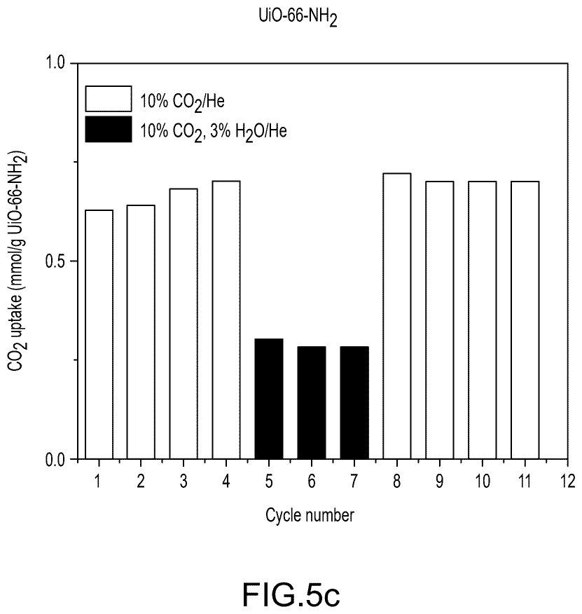

A preliminary breakthrough test was carried out to evaluate the CO₂ adsorption performance of SPC-3 in a lab-scale fixed bed reactor at 35° C. (see FIG. 5a). In a dry gas stream with a composition of 10 vol % CO₂/helium, SPC-3 exhibited reversible CO₂ sorption capacity of 0.69±0.04 mmol/g adsorbent (cf. FIG. 5b), compared to 0.68±0.03 mmol/g adsorbent for UiO-66-NH₂ (cf. FIG. 5c). Considering PVDF-HFP is almost transparent to gas adsorption, the comparison demonstrates that our mild fabrication technique manages to completely preserve adsorbent's sorption capacity. More importantly, SPC-3 showed an enhanced CO₂ sorption capacity up to 1.0 mmol/g adsorbent in a simulated coal-combustion flue gas consisting of 10 vol. % CO₂, 3 vol. % H₂O, and helium balance. The increase in CO₂ sorption capacity can be ascribed to the presence of water moisture which may promote amine-CO₂ interaction. For instance, SPC-3 showed a H₂O uptake approximately 5.5 mmol/g. On the other hand, the CO₂ sorption capacity of UiO-66-NH₂ decreased to 0.28 mmol/g adsorbent due to the strong competitive sorption of H₂O, indicated by a high H₂O uptake about 17.5 mmol/g. This wet gas test indicates that the hydrophobic nature of our SPCs can effectively protect CO₂ adsorbents from being overwhelmed by water moisture in the practical application conditions.

### Example 4: SPC-4 (60 wt % PVDF-HFP/40 wt % Glycine MOF-808

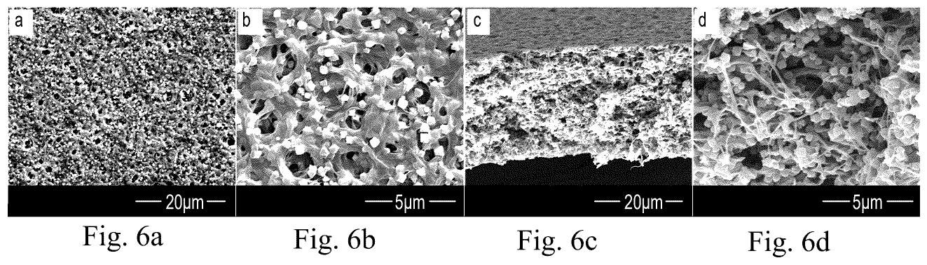

Due to the superior CO₂-philicity of alkyl amines relative to aromatic amines (such as those in UiO-66-NH₂), they provide a facile method for preparing highly stable Zr-based MOFs containing a high density of primary alkyl amines. Specifically, a 2-step “green” protocol has been developed to prepare MOF-808 particles functionalized with glycine. First, MOF-808 is synthesized in solution of water and formic acid using a recently reported protocol (ACS Sustainable Chem. Eng., 8, 17042, (2020)). Second, MOF-808 particles are washed with deionized water followed by immersion in an aqueous solution of NaOH and glycine and stirred overnight. Specifically, approximately 115 mg of MOF-808, 1.5 mmol of NaOH, and 250 mg of glycine were dispersed in 200 mL of deionized water and stirred for 24 hours at room temperature. The glycine-functionalized particles are then washed with DI water once again, solvent exchanged with acetone and ready for incorporation into polymer casting solutions. SPC-4 using glycine MOF-808 nanoparticles was then fabricated following the method described in Example 1, except that PVDF-HFP and glycine MOF-808 were mixed at a weight ratio of 60/40 and in a smaller batch. Specifically, the prepared suspension comprises 105 mg PVDF-HFP, 70 mg glycine MOF-808, 79 mg deionized water, and 1.13 g acetone. FIGS. 6a and b display surface micromorphology of the obtained SPC-4 membrane, which has a porous surface with glycine MOF-808 nanoparticles decorating among the surface pores. The SPC-4 has a thickness of 24 μm as shown in the full cross-section micrograph in FIG. 6c. The zoom-in cross-section image (FIG. 6d) shows that glycine MOF-808 nanoparticles are well dispersed in the polymer networks. Water contact angle measurement confirms that the porous surface of SPC-4 is hydrophobic, exhibiting a water contact angle in a range of 101-112°.

### Example 5: SPC Embedded with Hydrophobic PTFE Nanoparticle Fillers

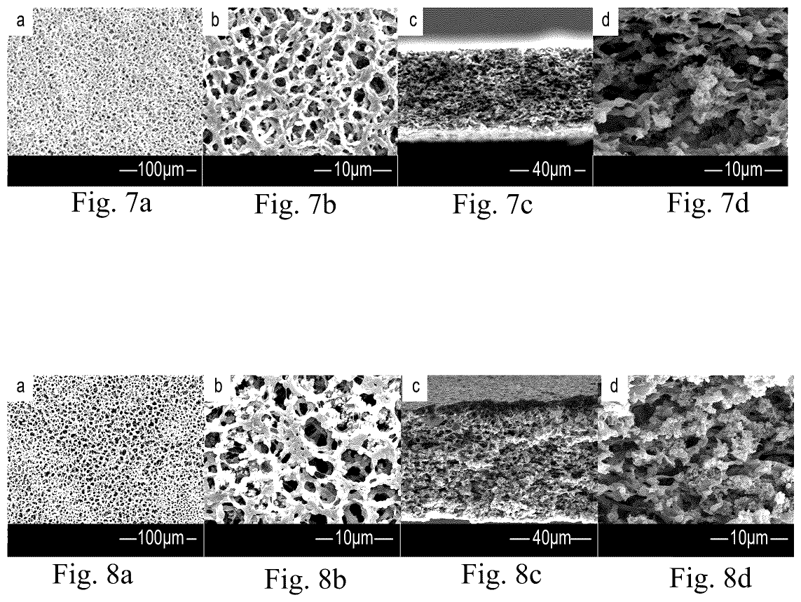

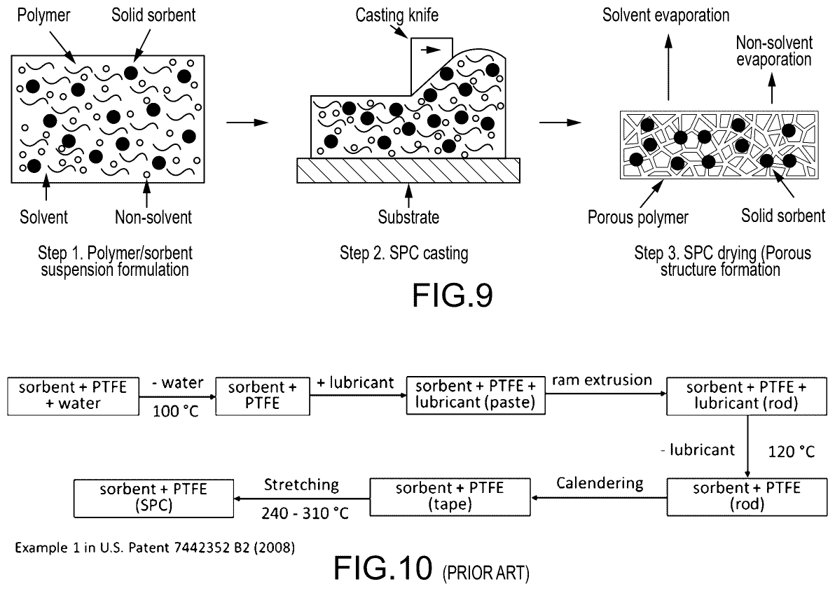

SPC membranes containing PTFE nanoparticles (<1 micron average diameter, Sigma Aldrich, St. Louis, MO) were prepared to increase the hydrophobicity of the resulting membranes using the same membrane casting methods as in Example 1. First, a porous PVDF-HFP membrane embedded with 9.1 wt. % PTFE nanoparticles was prepared to investigate the dispersity of PTFE nanoparticles in PVDF-HFP matrix in the following experiment. A polymer solution containing 0.5 g PVDF-HFP, 0.05 g PTFE powder, 0.375 g deionized water, and 5.375 g acetone was stirred in a capped vial at 50° C. until the PVDF-HFP had dissolved resulting in a colorless, slightly cloudy solution. The SPC membrane was cast on a glass plate after allowing the solution to cool to ambient temperature. SEM micrographs of the surface and cross sections (FIG. 7) show aggregated clumps of the PTFE particles within the PVDF-HFP polymer matrix. Spherical structures formed by PVDF-HFP encapsulating the PTFE clusters are also visible. Second, a SPC with 59 wt % PVDF-HFP, 19 wt % PTFE, and 22 wt % UiO-66-NH₂ was prepared in the following manner. A polymer solution containing 0.25 g PVDF-HFP, 0.08 g PTFE powder, 0.096 g Ui066-NH₂, 0.18 g deionized water, and 3.16 g acetone was stirred in a capped vial at 50° C. until the PVDF-HFP had dissolved resulting in an opaque white suspension. The SPC membrane was cast on a glass plate after allowing the solution to cool to ambient temperature. The resulting SPC had an average water contact angle of 131° when PTFE filler particles were included, which is significantly greater than those obtained for Examples 1˜4 in which SPC films did not include PTFE filler particles. FIG. 8 displays SEM micrographs of the surface and cross sections of the obtained PVDF-HFP/PTFE/UiO-66-NH₂ SPC, showing aggregated clumps of the PTFE and UiO-66-NH₂ within the PVDF-HFP polymer matrix as well as on the membrane surface.

The following summarizes possible alternative starting materials.
a. Polymer: To fabricate desirable SPCs in this invention, a solution-processable and hydrophobic polymer is a requisite, and any polymers with those two characteristics can be potentially used. Besides PVDF-HFP, other fluoropolymer materials suitable for the current invention include, but are not limited to: poly(vinylidene fluoride) (PVDF), poly(vinylidene fluoride-co-trifluoroethylene) (PVDF-TrFE), poly(vinylidene fluoride-co-chlorotrifluoroethylene) (PVDF-CTFE). Their chemical structure and physical properties are shown in Table 1.

TABLE 1
Examples of hydrophobic, solution-processable, and
commercially available polymers.

| | | Melting | Degradation |
|---|---|---|---|
| | | Temp. | Temp. |
| Polymer | Structure | (° C.) | (° C.) |
| PVDF | 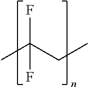 | 169 | 450 |
| PVDF- HFP | 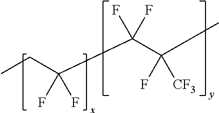 | 143 | 439 |
| PVDF- TrFE | 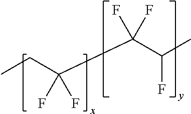 | 153 | 500 |
| PVDF- CTFE | 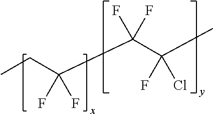 | 164 | 450 |

b. Solid sorbent Due to the mild processing conditions, nearly all solid adsorbents, consisting of physical and chemical types, can be potentially used for the current invention. Besides MOF UiO-66, a few other physical adsorbents include activated carbon, zeolite 4A, zeolite 13X, MOF Mg₂(dobdc), and MOF SIFSIX3-Zn. Whereas, chemical adsorbents are usually preferred to physical adsorbents in SPCs for the following considerations: (1) chemical adsorbents usually exhibit higher CO₂ sorption capacity than physical sorbents in flue gas with low CO₂ concentration; (2) the primary uses of SPCs are in wet flue gas, but most physical adsorbents exhibit decreased CO₂ sorption capacities under wet conditions due to more competitive adsorption of H₂O over CO₂. Besides MOF UiO-66-NH₂, a few other amine functionalized chemical adsorbents suitable for the current invention include polyethyleneimine-grafted UiO-66-NH₂, alkylamine-appended Mg₂(dobpdc), amine grafted or impregnated silica, or amine impregnated polymer. Some novel MOF-based adsorbents and their reported CO₂ adsorption capacity are summarized in Table 2. The sorption capacity of glycine MOF-808 adsorbents was determined by CO₂ adsorption isotherms collected on a Quantachrome Autosorb-1 instrument. Briefly, approximately 45-100 mg of each sample was added into a pre-weighed sample analysis tube. The samples were degassed at 90° C. under vacuum for ˜24 hours prior to initial analysis.

TABLE 2
Examples of MOF-based adsorbents and their CO₂ adsorption
capacity at different testing conditions.

| | CO₂ adsorption capacity | | |
|---|---|---|---|
| | (25-40° C., mmol/g) | | |
| | ~0.14 bar | 1.0 bar | |
| | humid | humid | |
| Adsorbents | (dry) | (dry) | References |
| UiO-66-NH₂ | N/A (1.98) | 2.1 (2.7) | Langmuir, 28, 15606, (2012) |
| | | | ACS Omega, 4, 3188, (2019) |
| Glycine | N/A (1.25) | N/A (3.25) | Measured at NETL |
| MOF-808 | | | |
| amine | N/A (2.33) | 3.3 (3.1) | ACS Omega, 4, 3188, (2019) |
| grafted | | | |
| UiO-66-NH₂ | | | |
| mmen- | 4.2 (3.8) | N/A (4.2) | Journal of the American |
| Mg₂(dobpdc) | | | Chemical Society, 134, 7056, |
| | | | (2012) |
| | | | Journal of the American |
| | | | Chemical Society, 137, 4787, |
| | | | (2015) |
| Mg₂(dobpdc) | 4.9 (4.9) | N/A (N/A) | Chemical Science, 7, 6528, |
| (N₂H₄)_{1.8} | | | (2016) |

c. Solvent Any low boiling point (bp, typically <100° C.) solvents that can dissolve PVDF-HFP can be potentially used. Besides acetone, a few other examples include tetrahydrofuran (bp=66° C.), butanone (bp=80° C.), acetonitrile (bp=82° C.) and their mixtures.
d. Non-solvent Any moderate boiling point (typically, bp of about 100° C.) solvents that are unable to dissolve PVDF-HFP can be potentially used. Water is a representative example. Besides, a class of alcohols are suitable for the current invention include, but are not limited to: 1-propanol (bp=97° C.), iso-butanol (bp=108° C.), 1-butanol (bp=118° C.), 2-butanol (bp=100° C.), 3-pentanol (bp=115° C.), and 2-pentanol (bp=119° C.). A few aromatic hydrocarbons, like toluene (bp=111° C.), ethylbenzene (bp=136° C.) and xylene (bp=139° C.), can also be potentially used as the non-solvent.
e. Solvent/non-solvent evaporation conditions (or drying conditions) The evaporation rates of solvent and non-solvent play a significant role in pore formulation of SPCs. Samples in Example 1-3 in this invention are dried in a fume hood at an ambient condition (room temperature of 25° C. and relative humidity of 60%). Other controlled drying conditions can be potentially adopted: for example, increasing temperature from 25 to 50° C. to speed up the solvent evaporation, and varying relative humidity from 20 to 90% to tune evaporation rate of the non-solvent.
f. In this work, we have identified conditions leading surprisingly to superior sorbent polymer composites. The use of relatively high concentration fluoropolymer solutions; for example, at least 7 mass % fluoropolymer, or at least 8 mass %, or 8 to 15 mass %, or 8 to 10 mass % fluoropolymer in a coating composition prior to phase inversion; a mass ratio of nonsolvent/solvent (for example water/acetone) of 0.2 or less, or 0.1 or less, or 0.02 to 0.10, or 0.04 to 0.08; and depositing the coating composition by knife coating onto a substrate.
Conventional sorbent polymer composites (SPCs) are made from polytetrafluoroethylene (PTFE) due to its outstanding hydrophobicity. However, PTFE is an expensive material and is difficult to process because it is insoluble in most organic solvents. For example, to embed solid sorbents into PTFE matrix, the sorbent/PTFE mixture must be heated and engineered at an elevated temperature near the PTFE melting point (about 300° C. or above). This harsh thermal condition also limits the uses of many cutting edge but thermally sensitive solid sorbents, including amine-rich sorbents and nano-sized metal-organic frameworks (MOFs), in these PTFE-based SPCs. In contrast, this invention provides an approach to produce cost-effective SPCs under mild processing conditions that allows the incorporation of numerous advanced solid sorbents. More specifically, the advantages of this invention over the existing ones for manufacturing PTFE-based SPCs are summarized in the following:
a. Good processability: In the realistic applications, SPC materials are manufactured and utilized as membrane contactors. The SPC fabrication process in this invention, as shown in Scheme 1, is based on one-step solution casting of polymers, which has proven to be a highly efficient and facile method to fabricate membranes in membrane industries. More importantly, our approach uses ambient temperature and involves no extreme conditions, making it easy to process as well as scale up. In contrast, manufacturing the existing PTFE-based SPCs requires complicated steps and harsh processing conditions. For example, Scheme 2 shows a typical procedure to make PTFE/sorbent SPCs, in which multiple dryings and extreme thermal conditioning (up to 310° C.) are present.
b. Simple fabrication technique: In this invention, the porous structure of the SPCs can be created in a simplified method due to polymer precipitation and phase separation induced by the rapid evaporation of the solvent with slow evaporation of the non-solvent, shortly, a solvent/non-solvent evaporation induced phase inversion technique. This mechanism produces SPCs with uniform pore structure throughout the entire material while retaining integrity. Moreover, pore size and surface hydrophobicity of SPCs can be tuned by simply varying the weight ratio of solvent and non-solvent. By contrast, conventional SPCs can be produced with a significantly different mechanism via stretching softening polymers to form pore openings near their melting temperature. The applied stretching process may cause solid sorbents to separate from the expanding polymers.
c. Low polymer cost: The hydrophobic polymer material (PVDF-HFP) used in this invention has substantially lower cost than PTFE. For example, 100 gram PTFE costs $185 at Sigma-Aldrich (A leading chemicals supplier worldwide), while 100 gram PVDF-HFP only costs $49 at the same vendor. Even though smooth and solid PVDF-HFP (water contact angle of) 89° shows less hydrophobicity than PTFEs (water contact angle of 108-114°), the porous and rough PVDF-HFP in our SPCs exhibits water repellent ability as good as the PTFE materials. For instance, SPC-1 has a water contact angle of 113°, and 110° for SPC-3.
d. Versatile sorbent options: In this invention, SPCs are prepared under mild conditions, for example, at ambient temperature and using mild solvent. Nearly all types of solid sorbents, physical adsorbents like activated carbon, zeolite and metal-organic frameworks (MOFs) and chemical adsorbents like amine impregnated or grafted solids (including silica and MOF), can be easily incorporated into our approach. Many advanced amine containing solid sorbents, especially amine impregnated solids, cannot withstand manufacturing temperatures as high as 240-310° C., which are typically required for making the existing PTFE-based SPCs.

1. A method of making a sorbent polymer composite membrane,
comprising: mixing a dissolved fluoropolymer and a sorbent in an organic solvent to form a mixture;
wherein the fluoropolymer and sorbent comprise at least 5 mass % of the mixture;
adding a nonsolvent to the mixture to form a phase inversion coating composition;
wherein the mass ratio of nonsolvent to solvent in the coating composition is 0.2 or less;
applying a film of the coating composition to a substrate via a casting knife;
vaporizing the solvent from the film at a temperature <150° C. from the mixture to increase the ratio of nonsolvent/solvent so that the fluoropolymer precipitates from the solvent; and
forming a porous fluoropolymer film with dispersed sorbent.

2. The method of claim 1 further comprising drying the porous fluoropolymer film at an elevated temperature above 30° C. to remove the solvent and nonsolvent.

3. The method of claim 2 wherein the elevated temperature is in the range of 30-100° C.

4. The method of claim 1 wherein the mixture comprises at least 7 mass %, or at least 8 mass %, or 8 to 15 mass %, or 8 to 10 mass % fluoropolymer plus sorbent.

5. The method of claim 1 wherein the mixture comprises at least 4 mass %, or at least 8 mass %, or 8 to 15 mass %, or 5 to 20 mass % or 8 to 10 mass % fluoropolymer.

6. The method of claim 1 wherein the coating composition has a mass ratio of nonsolvent/solvent (for example water/acetone) of 0.2 or less, or 0.1 or less, or in the range of 0.02 to 0.10, or 0.04 to 0.08 or 0.024-0.100.

7. The method of claim 1 wherein the step of vaporizing is conducted at <150 or <100 or <80° C., or in the range of 10⁻³⁰° C.

8. The method of claim 1 wherein the substrate is a fabric and the coating composition impregnates and adheres to the fabric.

9. The method of claim 1 wherein the sorbent comprises a zeolite, an activated carbon, a MOF, an amine grafted or impregnated silica, an amine functionalized MOF, or an amine impregnated polymer.

10. The method of claim 8 wherein the substrate is a wet fabric.

11. The method of claim 1 wherein the casting knife gap clearance is set in the range of 0.2-1.0 mm.

12. The method of claim 1 wherein the fluoropolymer and sorbent are adjusted so that the sorbent in the resulting membrane is in the range of 15-75 weight percent.

13. The method of claim 1 wherein the solvent is evaporated over a period of from 10 minutes to 24 hours, or 10 to 60 minutes, or 10 to 30 minutes or 1 to 10 minutes.

14. The method of claim 9 wherein the MOF comprises UiO-66, MOF-808, Mg₂(dobdc), or combinations thereof.

15. The method of claim 9 wherein the MOF comprises an amine functionalized MOF.

16. The method of claim 9 comprising a plurality of MOFs.

17. A membrane made by claim 1.

18-27. (canceled)

28. A method of functionalizing metal-organic frameworks (MOFs) with amines in a single step without the use of any organic solvents; wherein a MOF containing coordination sites available for carboxylate binding is soaked in an aqueous solution of a strong base and a molecule which contains both amine(s) and carboxylic acid groups.
